(19) United States
(12) Patent Application Publication
(10) Pub. No.: US 2022/0245326 A1
(43) Pub. Date: Aug. 4, 2022

(54) SEMANTICALLY DRIVEN DOCUMENT STRUCTURE RECOGNITION

(71) Applicant: Palo Alto Research Center Incorporated, Palo Alto, CA (US)

(72) Inventors: Edward Stabler, San Jose, CA (US); Kyle Dent, San Carlos, CA (US); Leora Morgenstern, Silver Spring, MD (US); Peter Patel-Schneider, Westfield, NJ (US); Charles Ortiz, Palo Alto, CA (US)

(21) Appl. No.: 17/162,561

(22) Filed: Jan. 29, 2021

(51) Int. Cl. G06F 40/14; G06F 16/901; G06F 40/253

(52) U.S. Cl. CPC G06F 40/14; G06F 40/253; G06F 16/9024

(57) ABSTRACT

One or more documents are received. Each document of the one or more documents is partitioned into segments using stylistic cues from a textual format of each document. Each of the segments is mapped to a respective embedding based on one or more language models. A dependency graph is computed based on the embeddings. A rooted, ordered tree is produced based on the dependency graph. The rooted, ordered tree represents a hierarchical structure of each document.

### TECHNICAL FIELD

The present disclosure is directed to document structure recognition.

### SUMMARY

Embodiments described herein involve a method comprising receiving one or more documents. Each document of the one or more documents is partitioned into segments using stylistic cues from a textual format of each document. Each of the segments is mapped to a respective embedding based on one or more language models. A dependency graph is computed based on the embeddings. A rooted, ordered tree is produced based on the dependency graph. The rooted, ordered tree represents a hierarchical structure of each document.

Embodiments involve a system comprising a processor and a memory storing computer program instructions which when executed by the processor cause the processor to perform operations. The operations comprise receiving one or more documents. Each document of the one or more documents is partitioned into segments using stylistic cues from a textual format of each document. Each of the segments is mapped to a respective embedding based on one or more language models. A dependency graph is computed based on the embeddings. A rooted, ordered tree is produced based on the dependency graph. The rooted, ordered tree represents a hierarchical structure of each document.

Embodiments involve a non-transitory computer readable medium storing computer program instructions. The computer program instructions, when executed by a processor, cause the processor to perform operations. The operations comprise receiving one or more documents. Each document of the one or more documents is partitioned into segments using stylistic cues from a textual format of each document. Each of the segments is mapped to a respective embedding based on one or more language models. A dependency graph is computed based on the embeddings. A rooted, ordered tree is produced based on the dependency graph. The rooted, ordered tree represents a hierarchical structure of each document.

### BRIEF DESCRIPTION OF THE DRAWINGS

FIG. 1A shows a process for determining a hierarchy of one or more documents in accordance with embodiments described herein;

FIG. 1B shows a process for finding one or more answers in a collection of documents in accordance with embodiments described herein;

FIG. 2 shows a block diagram of a system capable of implementing embodiments described herein;

FIG. 3 shows a more detailed process for finding an answer to a user query in a collection of documents in accordance with embodiments described herein;

FIG. 4 illustrates matrix of inner-product comparisons of elements of an example document in accordance with embodiments described herein;

FIGS. 5A and 5B show close-up views of portions of FIG. 4 in accordance with embodiments described herein;

FIG. 6A shows an example of a hierarchy of a document represented by a tree structure in accordance with embodiments described herein;

FIG. 6B illustrates the document hierarchy of FIG. 6B in a dependency format in accordance with embodiments described herein;

FIG. 7A shows an example of a hierarchy of a document represented by a tree structure in accordance with embodiments described herein; and

FIG. 7B illustrates the document hierarchy of FIG. 7B in a dependency format in accordance with embodiments described herein;

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Some questions are not specific enough to be answered with just one word or one phrase (‘factoids'). In a text, the answer to a question sometimes spans several paragraphs or even several pages. To provide such ‘long format’ answers, embodiments described herein involve a way to parse each document hierarchically into topics and subtopics—something like the ‘logical structure’ of the document, as intended by the author. The proposed method is more robust than any prior art, succeeding even when the source documents may have diverse authors and diverse structures. Recent technology has made significant progress in the accuracy of ‘factoid’ question answering. One of the datasets commonly used to assess recent factoid QA systems is SQuAD in which questions have an average length of 9 words and answers have an average length of 3 words. Often answers need to be slightly longer than 3 words, or involve some context that goes beyond 3 words, so we have for example the DuReader dataset or the Natural Questions dataset which has questions with an average of 9 words and answers with an average of 22 words. Answering some questions involves more words. Embodiments herein describe a way to determine a way to determine the hierarchical structure of one or more documents and use that structure to provide long-format answers to user queries.

Some questions need only one word or one phrase answers, but other questions require longer answers. In order to retrieve longer answers from a collection of possibly relevant documents, one might want to be able to find the segment, the ‘chunk’ of a document that provides the best answer to the question. Standard writing styles often help with identification of those chunks by providing titles, headings and tables of contents, but a document can, of course, be perfectly coherent and easy to understand without any of those things. The present approach will use those clues if present, but merges those clues with an assessment of content based on representations of what the segments of that document mean. The meaning representations do not need to be specially trained, but can be generic embeddings, vectors of real numbers chosen, roughly, to enable prediction of the contexts in which each segment of the text might occur. These embeddings can then be parsed into a coherent hierarchical graph using a sequence to-graph transduction and then flattened into a linearly ordered tree, similar to the parsing used for re-entrant semantic representations, or else a tree structure can be imposed on the graph directly as in unlabeled dependency parsing. For each node of the constructed hierarchical graph, a meaning representation is computed, which is associated with the source document and stored. Then when a user asks a question in a given context, that question and context can be similarly mapped to meaning representations, and the result can be used to find the best matching document segments in storage, e.g. using some version of approximate nearest neighbor or maximum inner product search (MIPS). This is known to outperform to td-idf, unigram/bigram, and other traditional methods.

Moving towards long format answers, one dataset developed for moving this direction is ELI5 with questions that average 42 words and answers that average 857 words. ‘abstractive’ approaches may be used that synthesize answers do less well than ‘extractive’ approaches that basically return a matching, coherent segment of a document. But these extractive approaches then face the problem of segmenting relevant parts of documents for each question. The traditional way to recognize document structure is to use ad hoc cues from textual format and relative positions. For example, titles may be in large font and occur early in a document, a table of contents, if present, occurs shortly after the title and usually lists page numbers, headings may be in an intermediate font size and may be bold and/or italicized, and may appear throughout the document, and sometimes headings and subheadings are numbered systematically. Unfortunately, all of these cues can be misleading. Other things besides headings can be in large or bold or italic fonts. If the table of contents and heading numbers are handwritten rather than automatically generated, they can be inaccurate. And of course, some numbered or otherwise highlighted lists are not headings at all. If the document was created in a hurry, or if the document format was automatically converted (e.g. pdf to html)—both of which are common for enterprise documents, for example—then there can be additional inconsistencies and all of these problems can become even more severe. For any application that needs to deal with documents from different authors and organizations, in different formats, these ad hoc approaches work rather poorly.

Given these difficulties, the ad hoc traditional approach may be replaced by statistical approaches. All of the mentioned hand-crafted cues to structure (font size, font weight, position in the document, etc) can be treated as features associated with the headings and paragraphs of the document, and then, given a corpus in which structure has been annotated, a system can be trained to predict document structure from those features in new texts. Some slightly more sophisticated methods also track vocabulary introduction and chains of related terms with tf-idf weights. Also relevant to the present work, but not parsing document structure, are machine learning studies that have trained neural networks to identify the order of sentences.

Embodiments described herein use a combination of the approaches described above. Although the present approach used a machine-learned model and machine-learned parser, it is unlike the representations computed by the machine learning approaches mentioned just above, the dense representations of document contents, ‘embeddings’, in the present approach are pre-trained and/or generic. For example, the embeddings can be calculated from unannotated text scraped from the internet—see e.g. the ‘Universal sentence embeddings’ described by Cer&al (2018) or the ‘Sentence-BERT’ embeddings described by Reimers&Gurevych (2019).

Embodiments described herein do not require document structure to be annotated in user documents, but instead compute embeddings using one or more language models. The one or more language models may be used to roughly predict masked words and next sentences. The reason these generic representations work is that human-written texts are usually coherent in the sense of proceeding from one topic to related ones in semantically sensible ways. The second difference between this approach and prior machine learning approaches is the use of a standard dependency-like parsing strategy to parse the sequences of embeddings of document elements. This kind of dependency parsing has become feasible for long inputs only recently, with the advent of near-linear time parsing methods. Therefore, parsing a document with 1000 or more elements can be done quickly.

Embodiments described herein can be used in a variety of applications. For example, a web browser that reads or describes the contents of a web page, in order, can be useful, but some web pages have many hundreds or even thousands of elements. Such pages can sometimes be quickly scanned visually, to see what is there, and what is being prompted for. Reading the contents to the user, according to the html structure itself, can be infeasible, especially because of the enormous variety in website designs, with so many ways to make a website visually clear and hand-usable. To provide someone with hands-free or eyes-free access to websites, it would be valuable to be able to answer, by paying attention to the meaning of the text, general questions like “what's on this page” and “what information is being asked for,” even if the html formatting tags are not well-designed to make that clear.

Embodiments described herein can be used for web document element insertion. Document structure analysis may be used for inserting an element into a web page in a coherent way. Traditional methods have been used for this, but a semantically driven approach could achieve better results, especially for poorly structured pages. Further, a question answering system that could read a document and explain it to a user in a conversation could be greatly benefited by the embodiments described herein

The methods described herein could be deployed in a first pass analysis for summarization of long documents, since this also relies on recognizing hierarchical relations among sentences and other elements. Current methods do not use document structure.

Various other applications could also benefit from the embodiments systems and methods described herein. For example, A coherent document could be generated that answers a set of questions. Embodiments described herein may be useful in assisting a bid team to find useful segments from previous proposals for use in responding to new RFPs. The proposed technology may be particularly useful when the user has a proprietary document base that cannot be shared and wants to retrieve sometimes long answers to general questions.

In general, in any case where possibly long answers to questions over a proprietary or specialized database are desired, the technology described herein could be deployed with very reasonable resource requirements. One particular example of this kind of application could be a search of proprietary meeting transcripts for discussions of a particular topic.

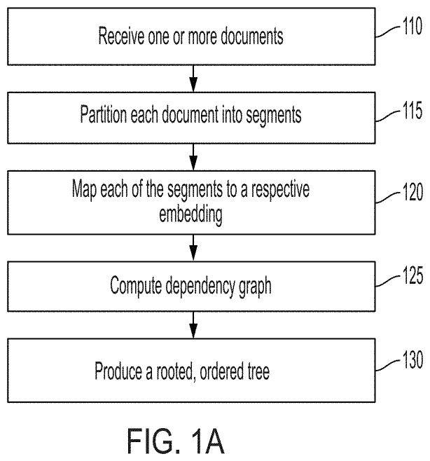

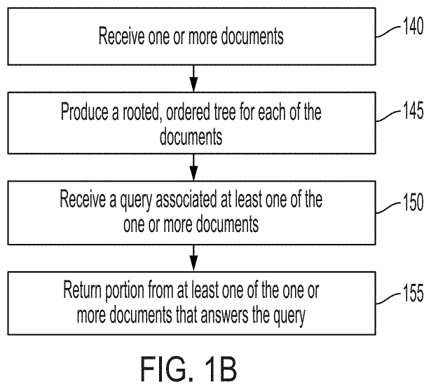

FIG. 1A shows a process for determining a hierarchy of one or more documents in accordance with embodiments described herein. One or more documents are received 110. According to various configurations, the one or more documents are part of a collection of documents in a database. At least a portion of the documents may have a common theme.

Each document of the one or more documents is partitioned 115 into segments using stylistic cues from the textual format of the respective document. For example, the stylistic cues may include headings, a table of contents, font style such as bold front and/or underlined font, for example. According to various embodiments, partitioning each document into segments may include partitioning each document into segments based on one or more document domains. The document domains may indicate a type of document format, for example. For example, the one or more document domains could include technical papers, news articles, manuals, proposals, and/or other business documents. According to various embodiments, an abbreviation library may be used to automatically recognize abbreviations within the document. The abbreviation library may be based on the document domain, for example. According to various configurations, for at least one of the document segments, the embedding corresponding to a respective segment is concatenated with a vector representing features of the respective segment and its associated context. The features may be computed using a rule-based system, for example

Each of the segments are mapped 120 to a respective embedding based on one or more language models. “Embedding” is a collective term for a set of language modeling and feature learning techniques in natural language processing in which words or phrases from a vocabulary are mapped to real number vectors based on their meaning, word usage, and context relative to other words in the vocabulary. In turn, words with similar meanings have similar vectors and are in proximity to each another in embedding space. Approaches to generate this mapping include neural networks, dimensionality reduction on a word co-occurrence matrix, and explicit representation in terms of the context in which words appear.

A dependency graph is computed 125 based on the embeddings. According to various embodiments, the dependency graph is configured to include hierarchical nodes that define how each segment is connected to other segments.

A rooted, ordered tree is produced 130 based on the dependency graph. According to various embodiments described herein, the rooted, ordered tree represents a hierarchical structure of the document. The rooted, ordered tree may include the document as the root and the position of a plurality of nodes (e.g., document segments) representing the hierarchical structure of the document. According to various embodiments described herein, ach of the plurality of nodes may be associated with a meaning representation.

FIG. 1B shows a process for finding one or more answers in a collection of documents in accordance with embodiments described herein. One or more documents are received 140. A rooted, ordered tree is produced 145 for each of the documents. According to various configurations, the rooted, ordered tree is produced at least partially using the process described in conjunction with FIG. 1A.

A query associated with at least one of the one or more documents is received 150. The query may be received by a user via a user interface, for example. In some cases, the query is generated as a part of an automatic process.

At least one portion of the one or more documents that matches the user query is returned 155 to the user. The at least one portion or segment may be text that substantially matches the user's query, for example. The system may return a predetermined number of portions. In some cases, the number of returned portions is configurable such that the user may select how many portions are to be returned. The returned document portion(s) may be displayed to the user on a user interface. In the event that more than one portion is retuned, the returned portions may be ranked based on a degree of match to the user query. The system may determine the at least one portion to return to the user using various methods. For example, the system may use one or more of an approximate nearest neighbor and a maximum inner product search (MIPS).

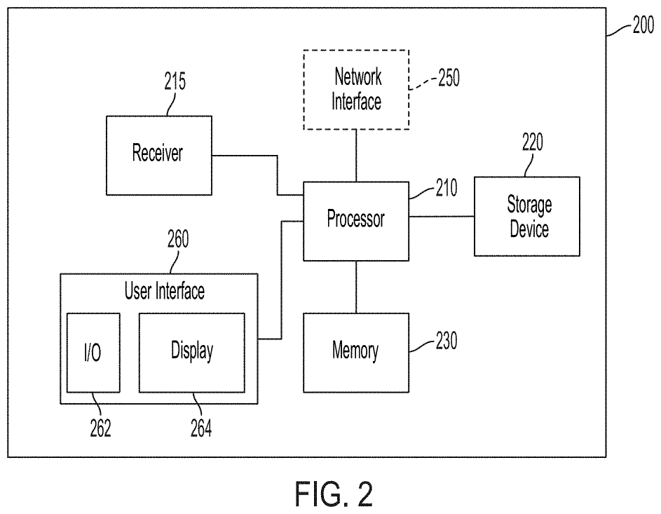

The methods described herein can be implemented on a computer using well-known computer processors, memory units, storage devices, computer software, and other components. A high-level block diagram of such a computer is illustrated in FIG. 2. Computer 200 contains a processor 210, which controls the overall operation of the computer 200 by executing computer program instructions which define such operation. The computer program instructions may be stored in a storage device 220 (e.g., magnetic disk) and loaded into memory 230 when execution of the computer program instructions is desired. Thus, the steps of the methods described herein may be defined by the computer program instructions stored in the memory 230 and controlled by the processor 210 executing the computer program instructions. The computer 200 may include one or more network interfaces 250 for communicating with other devices via a network. The computer 200 also includes a user interface 260 that enable user interaction with the computer 200. The user interface 260 may include I/O devices 262 (e.g., keyboard, mouse, speakers, buttons, etc.) to allow the user to interact with the computer. Such input/output devices 262 may be used in conjunction with a set of computer programs as an annotation tool to annotate training data in accordance with embodiments described herein. The user interface may include a display 264. The computer may also include a receiver 215 configured to receive data from the user interface 260 and/or from the storage device 220. According to various embodiments, FIG. 2 is a high-level representation of possible components of a computer for illustrative purposes and the computer may contain other components.

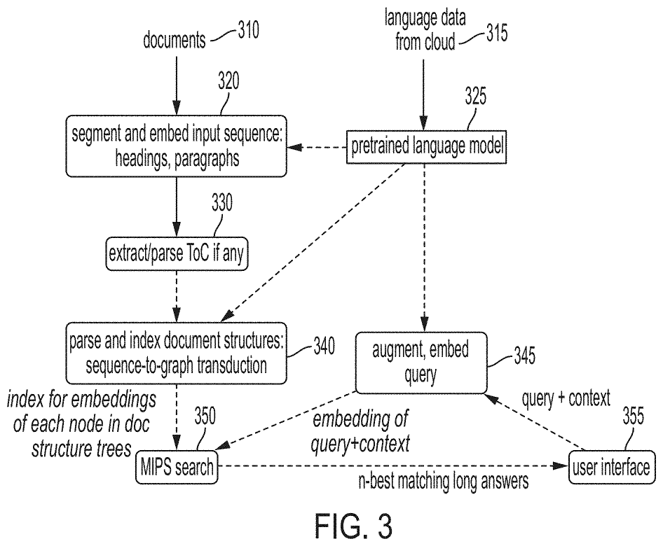

FIG. 3 shows a more detailed process for finding an answer to a user query in a collection of documents in accordance with embodiments described herein. The components are assembled behind a user interface 355 to provide a question-answering system that can answer questions, whether the answers short or long passages, according to what best matches the user query. The one or more documents are received 310. The documents are segmented and an input sequence is embedded using a pretrained language model. The pretrained language model 325 can be obtained using language data from the cloud 315, for example. The pretrained language model 3254 may also be used to parse and index document structures to convert the output sequence to a graph 340.

The user interface 355 may be used to receive a user query. The query may be augmented and/or embedded using the pretrained language model. The embedding of the query and context may be used in conjunction with an index for embeddings of each node for the tree structures to perform a search 350 (e.g., a MIPS search) in the one or more documents. At least one best matching long answers are received at the user interface 355 and may be displayed to the user. According to various configurations, the number of best matching answers may be adjusted by the user. In some cases, the number of best matching answers returned is not adjustable.

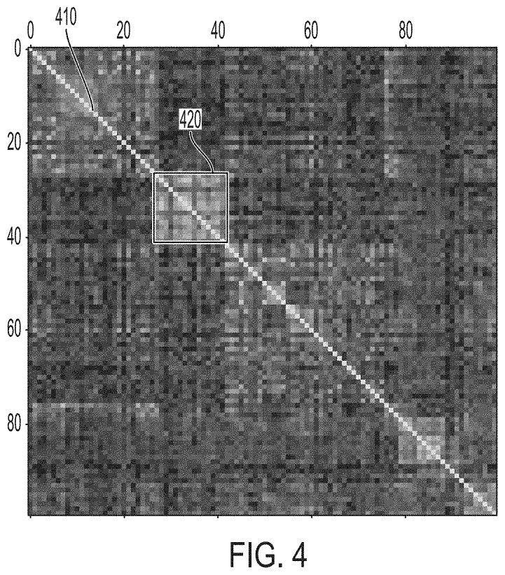

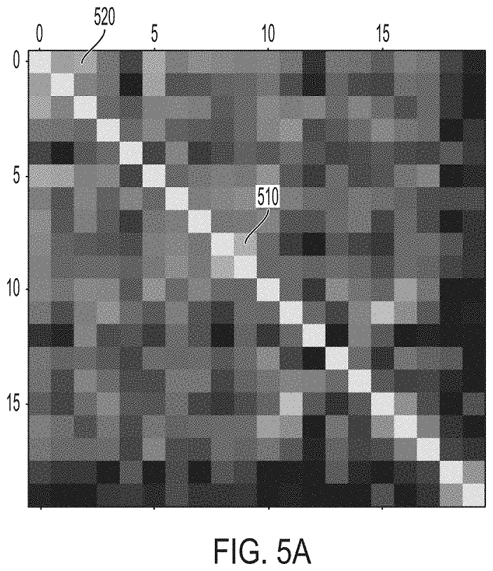

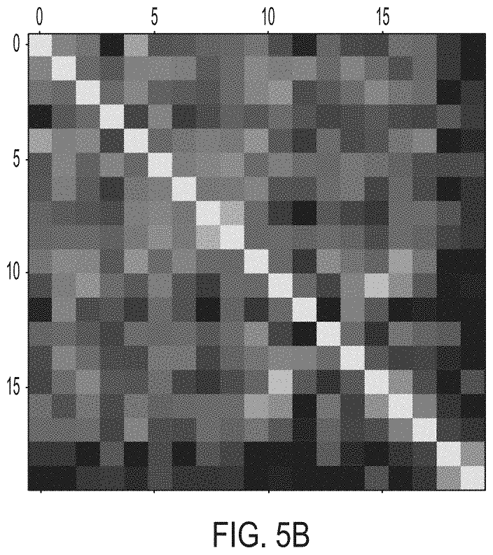

According to embodiments described herein, a key step of finding hierarchical structure, the step made by the sequence-to-graph algorithm, is similar to dependency parsing, except that the basic pieces are not words but headings and sentences or paragraphs, with style and format indications, representing each element with a sum of its embedding with a pretrained vector. Like the dependency parsing of sentences, dependency parsing of documents can be done in near linear time. For example, given document with 100 titles, headings, and paragraphs, the matrix of inner-product comparisons can be visualized as shown in FIG. 4 and the close up view in FIGS. 5A and 5B that show the semantic ‘closeness’ with the lightness of the color: Each row and column of FIGS. 4, 5A, and 5B shows the similarities of element i with each of the other consecutive elements, in order. Of course, each element matches itself best, on the diagonal, but notice that there several fairly close matches are not on but near the diagonal (e.g., 510, 520), signaling consecutive document elements that could possibly be joined into a larger unit. The lighter cubes along the diagonal 410 are the relatively coherent chunks, where the topic has stayed relatively similar and predictable.

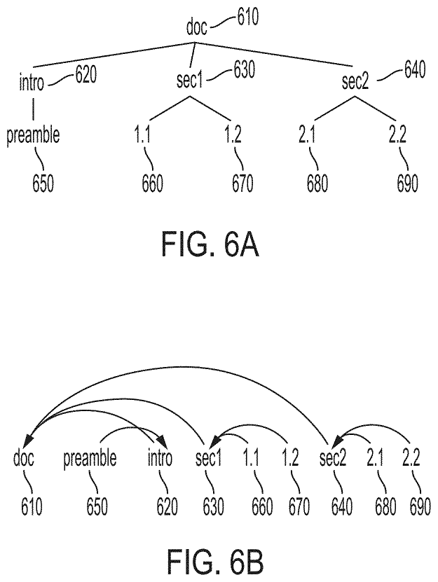

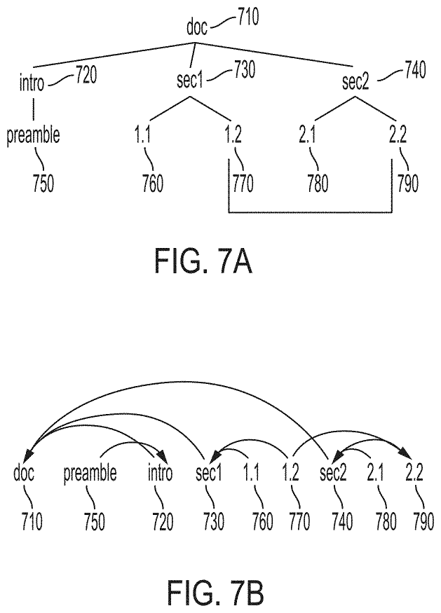

According to various embodiments, the one can identify larger cubes (e.g., 420) that have smaller cubes inside them. The larger cubes can be parsed into one or more tree structures that represent the logical structure of the document. The parser may be configured to merge most similar elements recursively: Each such step reduces the number of comparisons that can be relevant. The parser successively joins elements, weighting the options by compatibility with the table of contents if there is one, until all elements are included in one hierarchical tree structure, as in the example of FIGS. 6A-7B.

FIG. 6A shows an example of a hierarchy of a document 610 represented by a tree structure. In the tree structure, the document 610 is broken down into an introduction 620, section one 630, and section 2 640. Each of these units is broken down into one or more sub-units. The introduction is broken down into the preamble 650. Section one 630 is broken down into 1.1 660 and 1.2 670. Similarly, section two 640 is broken down into 2.1 680 and 2.2 690. The same hierarchy that is shown in FIG. 6A can be represented in a dependency format as illustrated in FIG. 6B. Here, it shows the subunits dependency on the different document units and all of the units are dependent on the document.

Similarly, FIG. 7A shows a hierarchical tree structure for a document 710. In the tree structure, the document 710 is broken down into an introduction 720, section one 730, and section 2 740. Each of these units is broken down into one or more sub-units. The introduction is broken down into the preamble 750. Section one 730 is broken down into 1.1 760 and 1.2 770. Similarly, section two 740 is broken down into 2.1 780 and 2.2 790. In this example, it is determined that section 2.2 790 is closely related to section 1.2 770. This may be determined based on a statement in section 2.2 790 that refers back to section 2.1 780, for example. FIG. 7B shows the dependency format for the tree structure shown in 7A. As can be observed, section 1.2 770 is connected to section 2.2 790 based on the determined relation.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The various embodiments described above may be implemented using circuitry and/or software modules that interact to provide particular results. One of skill in the computing arts can readily implement such described functionality, either at a modular level or as a whole, using knowledge generally known in the art. For example, the flowcharts illustrated herein may be used to create computer-readable instructions/code for execution by a processor. Such instructions may be stored on a computer-readable medium and transferred to the processor for execution as is known in the art. The structures and procedures shown above are only a representative example of embodiments that can be used to facilitate ink jet ejector diagnostics as described above.

The foregoing description of the example embodiments have been presented for the purposes of illustration and description. It is not intended to be exhaustive or to limit the inventive concepts to the precise form disclosed. Many modifications and variations are possible in light of the above teachings. Any or all features of the disclosed embodiments can be applied individually or in any combination, not meant to be limiting but purely illustrative. It is intended that the scope be limited by the claims appended herein and not with the detailed description.

1. A method implemented by a processor, comprising:
receiving one or more documents;
partitioning each document of the one or more documents into segments using stylistic cues from a textual format of each document;
mapping each of the segments to a respective embedding based on one or more language models;
computing a dependency graph based on the embeddings; and
producing a rooted, ordered tree based on the dependency graph, the rooted, ordered tree representing a hierarchical structure of each document.

2. The method of claim 1, comprising:
receiving a user query associated with at least one document of the one or more documents;
returning at least one portion of the at least one document based on the rooted, ordered tree and the user query; and
displaying the at least one portion of the at least one document.

3. The method of claim 2, wherein the at least one portion of the at least one document is text that answers the user query.

4. The method of claim 2, wherein determining at least one portion of the at least one document based on the rooted, ordered tree and the user query is done using at least one of approximate nearest neighbor and maximum inner product search (MIPS).

5. The method of claim 2, ranking the at least one returned portion of the at least one document.

6. The method of claim 1, wherein the rooted, ordered tree comprises a plurality of nodes, each node comprising a computed meaning representation associated with each document.

7. The method of claim 1, further comprising receiving an abbreviation library, and automatically recognizing abbreviations within the document based on the abbreviation library.

8. The method of claim 1, wherein partitioning each document into segments comprises partitioning each document into segments based on one or more document domains.

9. A system, comprising:
a processor; and
a memory storing computer program instructions which when executed by the processor cause the processor to perform operations comprising:
receiving one or more documents;
partitioning each document of the one or more documents into segments using stylistic cues from a textual format of each document;
mapping each of the segments to a respective embedding based on one or more language models;
computing a dependency graph based on the embeddings; and
producing a rooted, ordered tree based on the dependency graph, the rooted, ordered tree representing a hierarchical structure of each document.

10. The system of claim 9, wherein, for at least one of the document segments, the embedding corresponding to a respective segment is concatenated with a vector representing features of the respective segment and its associated context, the features computed by a rule-based system.

11. The system of claim 9, wherein the operations further comprise:
receiving a user query associated with at least one document of the one or more documents;
returning at least one portion of the at least one document based on the rooted, ordered tree and the user query; and
displaying the at least one portion of the at least one document.

12. The system of claim 11, wherein the at least one portion of the at least one document is text that answers the user query.

13. The system of claim 12, wherein determining at least one portion of the at least one document based on the rooted, ordered tree and the user query is done using at least one of approximate nearest neighbor and maximum inner product search (MIPS).

14. The system of claim 12, wherein the operations further comprise ranking the at least one returned portion of the at least one document.

15. The system of claim 11, wherein the rooted, ordered tree comprises a plurality of nodes, each node comprising a computed meaning representation associated with each document.

16. The system of claim 11, further comprising receiving an abbreviation library, and automatically recognizing abbreviations within the document based on the abbreviation library.

17. The system of claim 11, wherein partitioning each document into segments comprises partitioning each document into segments based on one or more document domains.

18. A non-transitory computer readable medium storing computer program instructions, the computer program instructions when executed by a processor cause the processor to perform operations comprising:
receiving one or more documents;
partitioning each document of the one or more documents into segments using stylistic cues from a textual format of each document;
mapping each of the segments to a respective embedding based on one or more language models;
computing a dependency graph based on the embeddings; and
producing a rooted, ordered tree based on the dependency graph, the rooter, ordered tree representing a hierarchical structure of each document.

19. The non-transitory computer readable medium of claim 18, wherein the operations further comprise:
receiving a user query associated with at least one document of the one or more documents;
returning at least one portion of the at least one document based on the rooted, ordered tree and the user query; and
displaying the at least one portion of the at least one document.

20. The non-transitory computer readable medium of claim 19, wherein the at least one portion of the at least one document is text that answers the query.
